(19) United States
(12) Patent Application Publication
(10) Pub. No.: US 2003/0171927 A1
(43) Pub. Date: Sep. 11, 2003

(54) Method and system for verifying or certifying traits of candidates seeking employment

(76) Inventor: John V. Bernard, Belvidere, NJ (US)

Correspondence Address: Reed Smith Shaw & McClay, LLP, 213 Market Street/ 9th Floor, P.O. Box 11844, Harrisburg, PA, 17108-1844, US

(21) Appl. No.: 10/090,228

(22) Filed: Mar. 5, 2002

(51) Int. Cl. G10L 21/00

(52) U.S. Cl. 704/273

(57) ABSTRACT

A method and system is provided for gathering, verifying and certifying information regarding traits of applicants in search of employment opportunities. The method and system allow a prospective job applicant who submits an application for employment, such as by posting a resumé to a web site on the Internet, to exercise the option of having information regarding one or more traits obtained, verified and/or certified. An applicant who chooses to avail himself or herself of the verification and certification option would consent to investigational activities concerning applicant's traits, to release of the results of the investigational activities to applicant and other designated persons, and to placement or association of a verification or certification symbol or other distinguishing marker with the applicant's resumé or application. The symbol or marker may serve as an indication that an applicant does, or does not, possess one or more traits. The symbol or marker may instead serve as an indication that verified information regarding one or more traits of an applicant is available for review. The symbol or marker may also serve as an indication that information provided by an applicant in the first instance has been investigated by an independent third party and certified as being accurate.

### FIELD OF THE INVENTION

The present invention relates to a method and system for gathering, verifying and certifying information regarding traits of job applicants who are searching for employment opportunities, including particular attributes, qualities, characteristics, skills and the like. An applicant who chooses to avail himself or herself of the verification or certification option, and whose traits are verified or confirmed by thorough investigational activities, can then have a verification or certification symbol or other distinguishing marker placed on or otherwise associated with his or her resumé, or with an application posted by the applicant electronically or online, such as on the Internet. The verification or certification symbol or other distinguishing marker notifies prospective employers that certain information dealing with a particular trait or traits has been verified or certified, and in some situations that such information is available to the employer. It also enables prospective employers to search for candidates who have made particular verified or certified information about their traits available, and further, allows prospective employers to select candidates for employment who possess whatever trait(s) the employer is searching for in filling its hiring needs.

### BACKGROUND OF THE INVENTION

There are myriad factors which an employer may take into account when it seeks to hire employees. Many of the attributes, qualities, characteristics, skills or other traits (collectively “traits”) that any person may possess, and that may be considered by an employer in making hiring decisions, are often amenable to placement on a standard resumé. For example, a person's educational background (such as institutions attended, number of years attended, programs of study, degrees obtained, grade point average and the like) is often a very important trait considered by employers. Similarly, a person's prior work experience (including, for example, years in the field, positions held, companies worked for, length of tenure at each company, job duties and responsibilities previously handled) is another critical trait which nearly any employer would take into account in considering whether or not to hire a particular candidate. It may also be important for prospective employers to know other traits, such as any publications or articles authored by an applicant, or whether or not an applicant has garnered any certifications or licensure in various skill sets or areas of expertise.

A major risk associated with the process of hiring someone solely on the basis of a resumé and an interview is that the employer is often in the position of having to assess and trust the applicant's truthfulness with regard to the information the applicant provides on the resumé or during the interview process. While limited means exist for verifying the accuracy of some representations commonly made by a job applicant, such as by telephoning personal references or requesting copies of transcripts from academic institutions attended by the job applicant, there are many instances where such means are not utilized because they are too burdensome for employers, or because the means are often ineffective in reliably verifying information provided by the applicant.

In addition to the problem of verifying the accuracy of data supplied by the candidate, employers are often desirous of obtaining information that is typically not provided on the standard resumé or job application. For example, many employers might wish to obtain an assessment test (such as a personality profile), measuring various behavioral and attitudinal characteristics of a prospective employee in addition to the traditional information gleaned from the interview process. In many instances, particularly in situations where a person”; moral character might be important to the performance of his or her job and/or the safety and security of the employer's business, the employer may be desirous of obtaining a criminal history check, security clearance, or other background check. The average job applicant rarely volunteers this type of information. Further, it is often difficult, uncomfortable, and perhaps not feasible for many employers to request, and/or obtain, such information from a job applicant. To the extent such non-traditional information is provided by the applicant, either in the first instance or at the request of the employer, the veracity of such information would still remain a question.

These concerns are heightened even further when the context of the employment search process involves the online arena (Internet, World Wide Web, or other multiple user network). Due to the nature of online communications in general (including the added level of anonymity over traditional forms of communication, the potential to electronically manipulate and thereby falsify data, and the possibility of security breaches occurring), the risk associated with relying upon data supplied by a prospective employee who utilizes an online job application or career web site is perceived by many employers as being greater than the risks employers customarily face in performing searches using the traditional paper resumé and in-person interview process.

Employers who are hesitant to take advantage of online mechanisms to search for and identify prospective employees may miss out on opportunities to consider potentially qualified and attractive candidates. In addition, many job applicants may possess particular attributes, qualities, characteristics, skills or other traits that do not avail themselves of being easily and readily communicated to prospective employers. Were a job applicant able to make such non-traditional information available to prospective employers—and do so in a secure, reliable fashion that both the job applicant and the prospective employer could feel comfortable relying upon—an applicant may find many more opportunities available to him or her that might not otherwise have revealed themselves had the prospective employers not been made aware of the traits.

Various web sites have been established on the Internet that are career/employment-oriented in their focus. These sites provide a centralized location for people who are in search of employment opportunities, and for employers who are searching for suitable candidates to potentially hire. For example, U.S. Pat. No. 5,884,270, entitled “Method and System for Facilitating an Employment Search Incorporating User-Controlled Anonymous Communications” (“the '270 patent”), discloses a system which can be used to allow an employer (the requester) to communicate with prospective candidates (the parties) whose background satisfies employment criteria provided by the employer without revealing the identity of the employer or the identities of the candidates. The '270 patent discloses the following as a specific example of the process: a software company may want to hire a programmer with 5+years experience in writing C++, who is willing to live in Seattle, who will work for between $100,000 to $150,000 in salary plus bonuses, and who wants the opportunity to work for a startup company with stock options in a publicly-traded company that could effectively double his salary. The system disclosed in the '270 patent could identify a dozen candidates from resumés stored in a database, and release information about these candidates only as authorized to the company and candidates without the company ever knowing the candidates' identities.

One of the more well-known such web sites presently available is http://www.monster.com (“Monster.com”), which is generally regarded as a leader in the niche market of web sites devoted to recruiting, employment, career planning, job searching and the like. Online career sites such as Monster.com compile data submitted to them by prospective job applicants and then categorize the data into various parameters, allowing employers in search of applicants possessing particular features or criteria to conduct searches using one or more of the available parameters. Using the career sites, employers can search databases containing employee qualifications and other credentials to identify candidates having qualifications matching the employer's search criteria. For example, an employer may want to limit its search to include only applicants who reside in a particular geographic location, to include only applicants having a specific graduate degree, or to include applicants having a certain number of years experience in a particular field. Of course, the possible combinations of search criteria are nearly infinite.

Using an online career site, a person seeking employment may be able to search connected databases containing hundreds of thousands of job opportunities. As with employers seeking prospective employees, individual applicants searching for employment may perform searches for suitable jobs using a variety of parameters, such as geographic location, job category, salary level, size of company, and the like. Users may also place their resumé online or complete an electronic job application, and have job opportunities delivered to them via e-mail. Monster.com also allows an individual user to establish a personal account within their site, where the user can build up to five resumés and cover letters. Three levels of resumé confidentiality protect privacy of the information. Users may create automatic “search agents” that e-mail the user when a job listing that matches their previously specified criteria is added to the site. In addition, Monster.com offers a career center, where users may obtain career advice and join in community discussions.

Currently, however, none of the parameters by which an employer may choose to conduct an online search relate to independently verified or certified criteria, attributes, qualities, characteristics, skills and other traits such as, for example, bonding status, software program certifications, grade-point average, education and trade credentials, criminal background, security clearances, licensing and integrity or assessment test. Therefore, by having to rely on information solely as it has been provided by the applicant himself or herself, employers must either accept the veracity of the information provided by the applicant (and thus assume the risk of unreliable representations and the possibility of hiring someone who possesses less of a particular trait than the job applicant represented he or she possessed), or forego hiring an applicant whose information may very well be entirely truthful and accurate.

In addition, applicants who possess superior traits that are not commonly provided in the format of a traditional resumé, or traits that do not easily lend themselves to being reliably communicated to third parties, and who are desirous of making information concerning those traits available to prospective employers to distinguish the candidate from other applicants, have no means of providing such information in a manner which would cause a prospective employer to be comfortable relying upon the accuracy of the information. Currently, employers interested in searching for candidates based on non-traditional information must either request the information directly from the applicant (risking delays, and possibly offending a candidate who does not feel it appropriate to request, or divulge, such information), or forego seeking the information (and thus risk hiring someone who possesses little or none of the particular trait). While an applicant is certainly free to provide such non-traditional information in his or her resumé or application, it may not be reasonable for prospective employers to rely upon the veracity of the candidate's own representations. Therefore, while employers may be able to search for eligible candidates based on traditional traits such as education levels, work experience and the like, there is a continuing need for reliable posting and searching concerning such traits. Additionally, there is a continuing need for reliable posting of non-traditional traits such as, for example, bonding and insurance certification and status, software program certifications, grade-point averages, education and trade credentials, criminal background, security clearances, licensing, and assessment tests. No online system currently gives an applicant the incentive and protection necessary to yield comfort in providing trait information, nor does any system currently provide prospective employers adequate incentive to rely upon an applicant's representations in making interview and hiring decisions.

Therefore, a continuing and unmet need exists for a method and system which allows for verification or certification of various traditional and non-traditional traits of candidates seeking employment, and which enables all employer to reliably search for prospective employees who are willing to make available particular trait information sought by the employer. The need also exists for employers to search within a group of candidates to identify those individuals who have made particular trait information available, and to further identify only those applicants who possess the desired trait(s) (or the desired level of a particular trait) which the employer may be seeking.

Further, the need exists for a method and system which will allow applicants seeking employment to provide trait information that is not commonly provided in the context of the traditional resumé. By submitting to verification, investigational activities, certification or other trait-determining processes which the employers will accept as being a reliable and trustworthy indicator of whether or not an applicant possesses a certain trait (and if so, to what level or extent), applicants thereby make themselves potentially more attractive to prospective employers.

### SUMMARY OF THE INVENTION

The present invention relates to a method for, and system of, gathering, verifying and certifying information regarding traits of job applicants who are seeking employment opportunities. The method and system of the present invention allows a prospective job applicant who submits an application for employment, such as an electronic posting of a resumé to a web site on the Internet, to simultaneously exercise the option of having information regarding certain traits obtained, verified and/or certified. Such traits may relate to information traditionally provided by an applicant on a resumé, such as education and training, grade point average (“GPA”), diplomas and degrees, and employment history. Additionally, the method and process allows the prospective job applicant to authorize investigational activities to obtain, verify and/or certify information not traditionally provided on a resumé. The present invention also permits the applicant to consent to release of information resulting from investigational activities to designated parties, and provides for the posting of such information on a secure server to enable employers to view the results of potential employees. Investigational activities include, but are not limited to: interviews and testing to obtain an integrity profile, an assessment test or an intelligence quotient (“I.Q.”); various background checks (including but not limited to criminal, financial, and security clearance background checks); verification of bonding and insurance certification and status, software training and certification, and licensing by means well known to those skilled in the art.

### DETAILED DESCRIPTION OF THE PREFERRED EMBODIMENTS

The method and system of the present invention permits job applicants seeking employment through electronic or online means, such as on the Internet, to provide verified or certified information regarding the applicant's possession of a given trait or traits. Additionally, the present invention permits a determination and electronic representation of the level or extent to which the applicant possesses given trait(s). By utilizing the method and system of the present invention, job applicants are able to differentiate themselves from other job applicants who may be competing with them for the same employment positions but who are not willing to submit, or have not submitted, to the obtainment by an independent third party of certain information regarding the applicant, or to independent third-party verification or certification of their resumé or application information. Some applicants and employers may also believe that the very step of choosing to have traits verified or certified demonstrates the applicant's honesty, ability to plan ahead, and initiative—qualities that are considered highly valuable in any employee.

The present invention also allows employers to search for and select from only those electronic resumés or online applications that have an associated verification or certification symbol or other distinguishing marker associated therewith. Many companies actually require applicants to produce proof of traits prior to being considered for any position. Having information regarding particular traits obtained, certified and/or verified in advance—without the need for the employer's involvement—saves both the applicant and the employer time. Rather than selecting one or more suitable applicants to interview from a pool of resumés, and then at some point later in the process obtaining, verifying and/or certifying information regarding particular traits of the applicant(s), the present invention allows an employer to choose from a pool of electronic applications and resumés that consists only of applicants whose trait information has been previously independently obtained and/or confirmed by a reliable third party.

The present invention addresses both information typically provided by an applicant on a resumé, or at least capable of being provided by an applicant, as well as information that either is not typically provided by applicants or information that most applicants would not have at their disposal and thus would not be able to provide. The present invention also addresses information that can be verified and then presented to a prospective employer in the form of a “yes” or “no,” or “positive” or “negative” type of response, as well as information that cannot be presented in such a black-and-white manner.

An individual's college grade-point average is an example of information that is typically provided by a job applicant and that is capable of being verified and presented to a prospective employer in a “yes” or “no” fashion. Pursuant to the present invention, an applicant may request that his college grade-point average be verified by an independent third party, following which a particular verification stamp will be placed on his resumé. An employer desirous of considering applicants whose GPA's had been independently verified could then limit its search to only those resumés having the particular “Grade-Point Average Verified” stamp thereon.

Whether or not an applicant is drug-free is an example of information that is not typically provided by a job applicant, but that is capable of being certified and presented to a prospective employer in a “positive” or “negative” manner. Pursuant to the present invention, an applicant may voluntarily submit to drug testing by an independent third party. If the applicant tests drug-free, he could then have a particular certification marker or other seal of approval associated with his resumé. An employer desirous of considering applicants who have been certified as being drug-free could then limit its search to only those resumés having the particular “Certified Drug-Free” marker thereon.

A person's criminal history, or lack thereof, is an example of information that often may be provided by an individual applying for a job which does not lend itself to being verified with a simple “yes” or “no.” Pursuant to the present invention, an applicant may indicate himself as having never been charged with or convicted of a crime, and then request that that information be verified An independent third party then investigates that individual's criminal history, and makes its findings available to any authorized parties.

An assessment test is an example of information that is not normally provided by an applicant, nor in most cases even capable of being provided by a an applicant, and that cannot be certified with a simple “yes” or “no” type format. Pursuant to the present invention, an applicant may request that assessment testing be conducted on him by an independent third-party. Once completed, thaw individual could then have a particular symbol placed on his electronic resumé to indicate that assessment test information on him was available. An employer desirous of considering only applicants who had submitted to the conducting of an assessment test and who had agreed to make that information available to prospective employers could then limit its search to only those resumés having the particular “Assessment Test Information Available” symbol thereon. Additionally, a hyperlink or Uniform Resource Locator (“URL”) address could be placed directly in association with the applicant's resumé that, when clicked on by a prospective employer, would take the prospective employer directly to the actual results of that applicant's assessment test.

The system and method of the present invention enables applicants to pre-qualify themselves for positions which will require a certain trait or traits. By eliminating the step of having the applicant's trait(s) investigated and verified or certified after being selected as a potential candidate (but prior to being further considered), both the prospective employer and the prospective employee save time and thereby avoid the accompanying delays in making hiring decisions that would otherwise result. Established career-oriented Internet sites will also benefit from the present invention, as it provides additional parameters by which employers may search for prospective employees. Typically, the fees which career sites charge employers for using their services are based on the number of parameters chosen by the employer for a particular search. The more parameters which the employer utilizes for its search, the greater the fee which it must pay to the career site.

In one embodiment of the present invention, the initial step is for an applicant to submit an electronic resumé or online job application to a recipient. In a preferred embodiment, the recipient is a web site on the Internet devoted to employment opportunities, whereby: (1) applicants may search the web site for employment opportunities in which they may be interested, post electronic resumés or online applications, and conduct related employment-seeking tasks; and, (2) employers may post job openings, perform searches for suitable applicants for a particular position, and conduct related recruiting tasks.

When an applicant submits an electronic resumé or online application to a recipient, the recipient will provide the applicant with an option which may be selected by the applicant to authorize the recipient and any other service provider to engage in investigational activities to obtain information necessary to verify or certify one or more of applicant's traits, and ultimately to associate a symbol or other distinguishing marker with the applicant's resumé or application to reflect the results of the investigation. As explained in more detail below, the option may be presented as a hyperlink or some other identifying display placed on the recipient's web site which, if chosen by the applicant, will lead the applicant through a series of additional screens or stages.

The applicant may request verification or certification, and provide consent to investigational activities and release of results, by any one of several different means. In one embodiment of the present invention, the recipient's online registration process will prompt the applicant to complete an online registration form by entering a variety of personal identifying information, such as the applicant's name, address, home phone number, social security number, interview location, and the like. The registration form may also request the applicant to select a form of payment for any fees associated with the posting, verification, or certification processes, preferably by credit card. In one embodiment, the applicant will be prompted during registration to consent to the conduct of investigational activities and release of results. Such consent to release may be global, or may be limited to identified designees such as the recipient and prospective employers. The consent preferably also specifies whether the applicant consents to automatic association of one or more verification or certification symbols or other distinguishing markers with the applicant's resumé or online application. Additional prompts may be included to identify one or more parties to whom the recipient or other service provider should notify of the investigation results and applicant's trait status. As further described herein, in another embodiment, the applicant's consent to release of investigational results and association of a symbol or marker is solicited, or re-confirmed, following applicant's review of the investigational results. In yet another embodiment, the applicant may specify that no symbol or marker should be automatically associated with his or her resumé, even in the event the investigation results are favorable.

Investigational activities may be conducted by the recipient of an electronic resumé or online application, or by a third party service provider. Following receipt, investigational activities may be performed online, or may also involve certain steps that must be performed off-line. In one embodiment, the recipient of the applicant's electronic resumé or online application would have previously entered into an arrangement with one or more service providers. All applicants wishing to present a resumé to that particular recipient and have trait information obtained, verified or certified would then be required to submit or consent to investigational activities conducted by the recipient, or by the service provider previously chosen by the recipient. By utilizing an independent third party for obtaining, verifying or certifying particular information, and not simply relying upon an unsubstantiated representation made by the applicant himself or herself, the recipient and any prospective employers can be confident that accurate and trustworthy information is being reliably associated with a particular applicant's electronic resumé or online application.

In one preferred embodiment, a career/employment web site enters into an arrangement with a service provider capable of verifying or certifying a particular trait or traits. Pursuant to the arrangement, an agreement is reached whereby all users of the career/employment web site's services who desire verification or certification of their representations will be required to use the services of the service provider previously chosen by the career/employment web site. For example, a hyperlink to the service provider's web site may be provided on the career/employment web site. A job applicant desirous of having one or more traits verified or certified clicks on the hyperlinks associated with each particular trait, and is then taken to the service provider's web site for further instructions. After choosing the verification or certification option and being taken to the service provider's web site, the applicant is presented with a variety of information relating to the verification or certification processes.

In another embodiment, the applicant may electronically receive a form from the career site or service provider requesting that the applicant proceed through the verification and certification process. Preferably, the applicant would complete the form, and then mail or electronically submit the form to the service provider with payment of the fees for the necessary investigation, verification and certification processes. In yet another embodiment, the applicant may register by phone by calling the service provider and paying the investigation fee with a credit card. The fee which is charged may include only the fee for the investigation itself. Optionally, in any embodiment, the fee may include an additional charge above the cost of the investigation itself, including a fee for the service provider to associate its certification symbol or other distinguishing marker with the applicant's resumé or application and to make trait information available to a certain number of recipients, such as one or more career-oriented web sites on the Internet.

In one embodiment of the invention, an applicant provides all relevant trait information on the resumé or online application, and requests the recipient to arrange for investigational activities to verify whether the applicant truly possesses one or more represented traits. A corresponding verification symbol or other distinguishing marker is then placed on or otherwise associated with the applicant's electronic resumé or online application to reflect the information and results from the investigational activities. Markers may represent verification of single represented traits, multiple represented traits, or all represented traits, and should reflect whether that person possesses, or does not possess, the represented trait. Preferably, the symbol or marker would quantify and qualify each represented trait, as well as the accuracy of the applicant's representations of each trait. For example, if the applicant's representations with respect to a particular trait (such as GPA or current licensure) are absolutely accurate, a marker such as “Verified—100% Accurate” would be associated with the resumé or online application. Alternatively, if some representations were only partially accurate or were entirely inaccurate, markers such as “Partially Accurate” or “Inaccurate”, respectively, would be associated with the corresponding traits. The marker may additionally qualify and quantify the investigational results by providing electronic access to relevant information gathered during the investigational activities. Such qualification and quantification can be accomplished by means well known to those in the art, including but not limited to hypertext or hyperlinks associated with or linked to the certification symbol or marker.

In another embodiment of the invention, an applicant provides relevant information on the resumé or online application, and requests the recipient to arrange for certification of additional traits. The additional traits may be traits which are represented on the electronic resumé or online application, or may be unrepresented traits identified by the recipient or other parties, such as prospective employers. For example, the additional traits may include security clearances, background checks, assessment tests, or other relevant qualitative traits. A recipient of the resumé or online application would then arrange for the investigational activities to obtain the information necessary to certify whether the applicant truly possesses each identified additional trait. The recipient or a service provider would conduct investigational activities relevant to each identified trait to yield results. A corresponding marker is then placed on or otherwise associated with the applicant's electronic resumé or online application to reflect the results of the investigational activities concerning the additional trait(s). Markers may represent certification of single additional traits, multiple additional traits, or all additional traits, and should reflect whether that person possesses, or does not possess, the additional trait. Preferably, the symbol or marker would quantify and qualify each additional trait. For example, where the applicant made no representations as to military security clearances, and the investigational activities confirmed that the applicant did possess military security clearances, a symbol or marker such as “Security Clearance Certified” would be associated with the resumé or online application. Ideally, the symbol or marker would additionally qualify and quantity the investigational results by providing electronic access to relevant information gathered during the investigational activities, in effect supplementing the applicant's representations. Such qualification and quantification can be accomplished by means well known to those in the art, including but not limited to hypertext or hyperlinks associated with the certification symbol or marker and which may contain certified investigational results concerning the trait(s).

In an alternate embodiment, a job applicant may submit a traditional hard-copy resumé via means that do not involve the Internet (such as by regular mail of facsimile) and still avail himself of the benefits of the present invention. In this alternate embodiment, an applicant still requests that investigational activities be conducted by an independent third party in order to obtain, verify or certify particular trait information regarding the applicant. Once the results have been made available to the applicant by the independent third-party, the applicant then places the certification symbol or other distinguishing marker on his resumé. For example, who submits to drug testing and is revealed to be drug-free would then place a notation on his resumé to that effect, along with a URL address that corresponds to the location of his test results on the Internet. A prospective employer in receipt of the applicant's resumé would then utilize the URL address to view the results of applicant's drug test on the Internet. The independent third party would have previously posted the applicant's test results at the URL address on a secure server, that when accessed by a prospective employer would provide the necessary assurances that the information was reliable.

The present invention also presents applicants with an option during the online a application or registration process that allows them to search for a service provider's investigational facilities, if necessary to conduct investigational activities. Depending upon the traits selected for verification or certification, an applicant may be required to visit one or more investigational facilities to participate in investigational activities such as interviews, assessment tests, and other necessary testing. In one embodiment, the applicant is prompted to enter their postal zip code, following which a list of one or more facilities associated or otherwise affiliated with the service provider is electronically presented to the applicant, based on the facility being located within or near the postal zip code entered by the applicant. In another embodiment, the applicant may choose to electronically view the complete list of investigational facilities associated or otherwise affiliated with the service provider, and then simply review the complete list and select a facility that is most convenient to the applicant.

Preferably, the recipient or other service providers should include multiple facilities located in and around the geographic area(s) from which the large majority of applicants will originate. For example, if the particular recipient, such as a career-oriented web site on the Internet, wished to make its services available to job seekers and employers across the country, the service provider may need to have a sufficient number of investigational facilities of its own throughout the country, or enter into associations or affiliations with other facilities, so as to provide a suitable number of facilities for job applicants to travel to, from anywhere in the country.

In one embodiment, upon receipt of the applicant's electronic resumé or application, the service provider sends an investigation form directly to the applicant. The applicant then takes the form to the predetermined facility, and submits to interviews, tests, and other investigational activities. Once the applicant registers with the service provider, selects an investigational facility at which to have any necessary investigational activities conducted, travels to the facility and provides any necessary additional information, the service provider performs the applicable investigational activities.

As previously described, release of investigational results and association of corresponding markers will depend upon the consent provided by the applicant. In one embodiment, the applicant provides prior consent to automatic release of investigational results to identified parties and to association of corresponding markers with the applicant's online application. In another embodiment, the applicant's consent, or confirmation of earlier consent, is solicited after applicant review of the investigational results and associated markers prior to release to third parties. In a preferred embodiment, the results could be previewed by the applicant by securely accessing the results on the web site of the recipient or service provider. Preferably, the applicant would receive notice electronically, such as by e-mail from the recipient or service provider indicating that results were available for access. The applicant would gain access through prompts and entry of a password or personal identification number in conjunction with other identifying information such as the applicant's social security number, to access the results once they are posted. Alternatively, the applicant may choose to have results sent by regular mail and not be posted to the service provider's web site. In a preferred embodiment, in order to protect the applicant's privacy, only the service provider is made aware of the investigation results. The service provider then provides the results directly to the applicant. If the applicant initially registered online, such as via the Internet, then the service provider may post the results electronically, so that they may be accessed online by the applicant. Suitable security measures are utilized to protect the privacy and confidentiality of the information, such as by providing access to the investigation results only upon entry of the applicant's social security number and a password that the applicant has previously selected.

To obtain the investigation results online, an applicant accesses a particular web site on the Internet, such as the service provider's web site, whereupon a prompt is given for the applicant wishing to retrieve test results to enter the necessary security information, such as the applicant's social security number and pre-selected password. The service provider may optionally send the applicant an e-mail to notify them that the results are available for the applicant to access online. If the applicant initially registered by mailing in the completed registration form or by telephone, the service provider can mail the investigation results to the applicant. Alternatively, an applicant registering by regular mail or by telephone may indicate at the time of registration that he or she wishes to receive the investigation results electronically, such as by accessing them online via the Internet. In that instance, the electronic method of online posting will be utilized to communicate the results to the applicant. Once the applicant accesses the appropriate web site and enters the necessary identification and security information, such as the applicant's social security number and pre-selected password, the applicant may be asked to confirm the name and address of the person for whom they are attempting to request investigation results. If the applicant has entered the correct identification and security information, then his or her investigation results are then presented.

In one embodiment, if the applicant's traits are confirmed by the investigation results, a verification or certification symbol or other distinguishing marker is placed on, or otherwise associated with, the applicant's electronic resumé or online application. The resumé or application with all associated markers is also sent to the recipients previously designated by the applicant, such as a career-oriented web site on the Internet. As previously described, the timing of the placement of the marker for those applicants whose traits are verified or certified can be established in advance, so that it automatically occurs upon return of favorable investigation results. Alternatively, an applicant may instead desire that even if the applicant's results are favorable, that the applicant be contacted before placement of any marker is effectuated. In any embodiment, once the marker is placed on the applicant's resumé, employers are able to utilize the system of the present invention to search for suitable applicants based on the presence (or absence) of the marker.

In another embodiment, wherein the applicant has broadly consented to release of investigation results either prior to or subsequent to the investigational activities, the service provider places a marker on (or otherwise associates a marker with) the applicant's electronic resumé or online application to reflect the investigational results, whether favorable or unfavorable. The service provider then releases the marker, the investigation results, or both, to all designated parties which may include career/employment web sites, employers, and other recipients. In yet another embodiment, each service provider is permitted to determine the conditions under which it will release unfavorable investigational results, i.e., results that do not confirm claimed trait, which refute a claimed trait, or which reveal the presence of an undesirable trait. In a preferred embodiment, the unfavorable results are first reviewed again by the service provider for accuracy and correctness. In this embodiment, the service provider next communicates the results to the applicant pursuant to the procedures previously described in connection with communicating an investigational result to an applicant. In one embodiment of the invention, the service provider defers to the applicant, who may direct that no marker should be associated with applicant's resumé or online application, and that no release of results should be made to any third party, including recipients initially identified by the applicant during registration as parties to whom the investigational results should be sent. In this embodiment, the applicant may also direct that so third party be advised that the applicant chose to submit to investigation and certification of traits.

The present invention is not limited in any way to the types investigational activities that may be administered, nor to the types of information which may be obtained, verified or certified. Although the preferred embodiments have been described in detail, it should be understood that various changes, substitutions and alterations can be made without departing from the spirit and scope of the invention as defined by the appended claims.

I claim:

1. A method for providing verified information regarding a trait of an applicant seeking employment by submitting an application, comprising the steps of a first recipient:
(a) receiving an application from an applicant seeking employment;
(b) providing a means by which said applicant requests that investigational activities be conducted to yield results concerning said trait;
(c) receiving said results of said investigational activities; and
(d) associating with said application a distinguishing marker corresponding to said results of said investigational activities.

2. The method of claim 1, wherein said request that investigational activities be conducted is communicated by said applicant electronically.

3. The method of claim 2, wherein said request that investigational activities be conducted is submitted by said first recipient to a second recipient.

4. The method of claim 3, wherein said means by which applicant requests investigational activities further comprises an electronic hyperlink to said second recipient.

5. The method of claim 1, wherein said results of said investigational activities are received electronically.

6. The method of claim 1, wherein said distinguishing marker is associated with said application electronically.

7. The method of claim 1, wherein said request that investigational activities be conducted is communicated electronically from said first recipient to a second recipient, and said results of said investigational activities are received by said first recipient from said second recipient.

8. A system for providing verified information regarding a trait of an applicant seeking employment by submitting an online application, comprising:
(a) means for a first recipient to receive an electronic application from an applicant seeking employment;
(b) means by which said applicant electronically requests that investigational activities be conducted to yield verified results concerning said trait;
(c) means for receiving said results of said investigational activities; and
(d) means for associating with said application a distinguishing marker corresponding to said results of said investigational activities.

9. The system of claim 8, wherein said means by which applicant electronically requests that investigational activities be conducted comprises an online registration form which is completed by said applicant and submitted electronically.

10. The system of claim 9, wherein said completed online registration form is submitted by said first recipient to a second recipient.

11. The system of claim 10, wherein said means by which applicant electronically requests that said investigational activities be conducted further comprises an electronic hyperlink to said second recipient.

12. The system of claim 8, wherein said results of said investigational activities are received electronically.

13. The system of claim 8, wherein said distinguishing marker is associated with said application electronically.

14. The system of claim 8, wherein said request that investigational activities be conducted is communicated electronically from said first recipient to a second recipient, and said results of said investigational activities are received by said first recipient from said second recipient.

15. A method for certifying information regarding a trait of an applicant seeking employment by submitting an online application, comprising the steps of:
(a) a first party receiving from a second party a request that said first party perform investigational activities, said applicant having previously sent an electronic application seeking employment to said first party and requested that investigational activities be conducted;
(b) said first party performing said investigational activities to yield results;
(c) said first party communicating said results to said applicant; and
(d) said first party determining whether applicant wishes to have an identifying symbol associated with said application to reflect said results.

16. The method of claim 15, further comprising the step of:
(e) said first party communicating said results to said second party.

17. The method of claim 15, further comprising the step of:
(e) said first party associating an identifying symbol with said application to reflect said results.

18. The method of claim 17, further comprising the step of:
(f) said first party electronically transmitting to said second party said application, said application having said identifying symbol associated therewith.

19. The method of claim 15, wherein said electronic request that said first party conduct investigational activities includes an electronic hyperlink from said second party to said first party.

20. The method of claim 15, wherein said distinguishing marker comprises means for electronically presenting information gathered during investigational activities.
